(19) United States
(12) Patent Application Publication
(10) Pub. No.: US 2020/0080332 A1
(43) Pub. Date: Mar. 12, 2020

(54) Automated Bicycle Storage Facility

(71) Applicant: Charlotte Bax, Sierra Madre, CA (US)

(72) Inventor: Charlotte Bax, Sierra Madre, CA (US)

(21) Appl. No.: 16/114,038

(22) Filed: Aug. 27, 2018

(51) Int. Cl. E04H 6/00; E04H 6/14

(52) U.S. Cl. CPC E04H 6/005; G06Q 50/30; E04H 6/14

(57) ABSTRACT

A system and method to store a bicycle, with the bicycle transported by a tracked, chain-driven conveyor, the bicycle protected from damage by a container and protected from theft by locking the container and using a code to establish the right to access the bicycle for retrieval.

### BACKGROUND OF THE INVENTION

Masses of parked bicycles can be a nuisance. They can block the flow of pedestrians and vehicle traffic. They can also be a problem for bikers. When many bicycles are parked together, parking and retrieving a bicycle can cause unnecessary delay, and it can be a challenge for someone to access and retrieve their bicycle safely and without harming their bicycle or others' bicycles. Also, if people are allowed to freely access the parked bicycles, then the bicycles are in danger of being stolen. If bicycles are parked in an outdoor area, then they are exposed to weather, which damages them over time.

There is a need for a device for bikers to store their bicycles in a structure without bikers having to enter the structure to park or retrieve their bicycles, and with limited access to the bicycles by the public, including other bikers. There is a need to store the bicycles in a space-efficient way, but without the bicycles contacting each other. And there is a need for bicyclists to leave and retrieve their bicycles quickly.

### SUMMARY

A storage facility for bicycles, comprising containers for bicycles, a tracked conveyor to move containers within a covered facility, and an elevator to deliver containers to and from a tracked conveyor.

### DESCRIPTION OF THE DRAWINGS

FIG. 1 shows a multi-story facility for storing bicycles. Bicycles are placed in containers, which are transported by elevator to floors in a covered area, where tracked conveyors move them to storage locations.

FIG. 2 shows a container for a bicycle and a container platform. The container platform supports the container while in the elevator and can move the container into and out of the elevator.

FIG. 3 shows a diagram of an information-processing system for the bicycle storage facility.

FIG. 4 shows steps in a method of using the facility to store and retrieve a bicycle.

### DETAILED DESCRIPTION

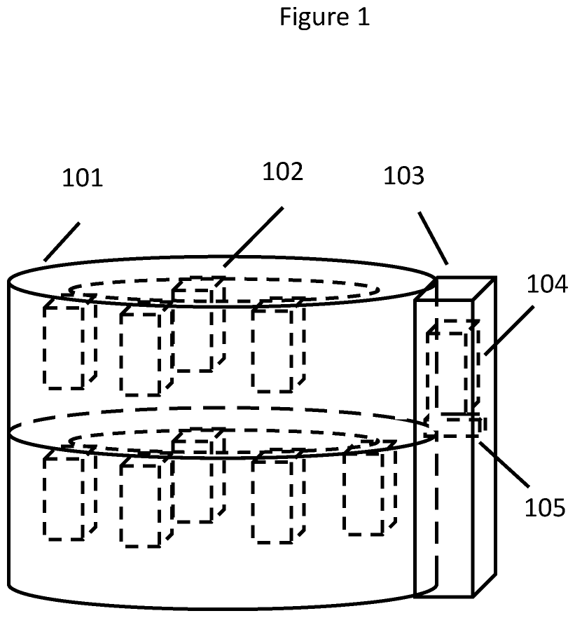

FIG. 1 shows a storage facility for bicycles. There is a covered structure 101. The structure may have one or multiple levels (two are shown), above ground, below ground, or at ground level. The ground level may be clear of bicycle storage to allow vehicle or pedestrian traffic to pass through. Each level has a tracked conveyor 102, similar to those commonly found in dry cleaning shops or factories. The tracked conveyor comprises a chain, supported by a track, and a chain drive mechanism to advance the chain within the track. The track may be in a circular pattern (as shown in FIG. 1) or in some other configuration, such as weaving back and forth across the level.

There is also at least one elevator 103, with openings to the inside and outside of the structure. The openings may have doors. The elevator can ingest a container 104 and lift or lower it to a level of the structure. There, the container may be transported within the level by the tracked conveyor 102. The elevator can also lift or lower a container platform 105. The container platform 105 supports a container 104 and can move it from the elevator to a position to be attached to a tracked conveyor 102.

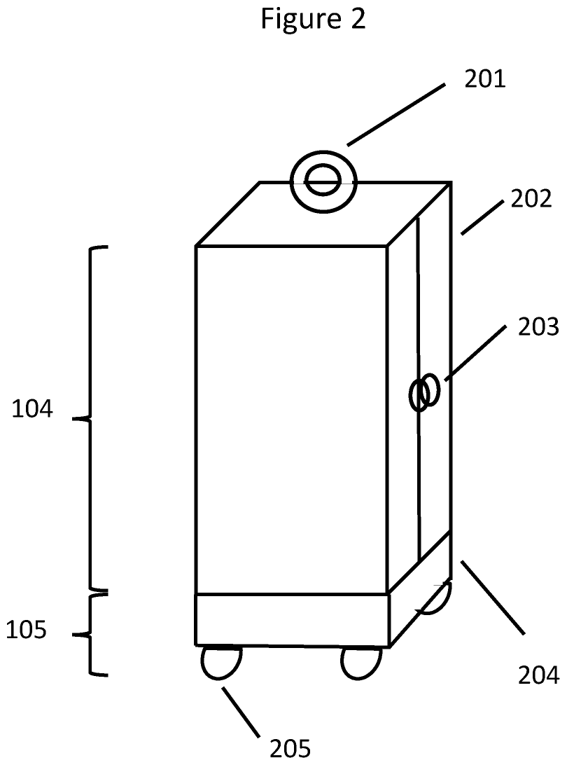

FIG. 2 shows, in more detail, a container 104 and a container platform 105. The container comprises a means to attach to a conveyor 201, which may be a ring (shown), a hook (to fit rings on the chain of a conveyor), or some other device for supporting the weight of the container and its contents while they are transported by the conveyor, doors 202 or some other means of making an opening in the container such as a zipper, and a pair of rings 203, handles, or other means of using a lock to secure the container.

The container platform 105 comprises a base 204 to support a container and wheels 205 or other means to move the platform 105 and container 104. The container platform transfers the container 104 from the elevator 103 to a conveyor 102 for storage, and the reverse for retrieval. The container platform may be attached to the elevator floor and slide out of it like a drawer, with wheels fitting into tracks on the sides of the elevator.

The container platform may have a means of lifting and lowering a supported container. Then if the container has a ring or other opening at the top and the conveyor has a hook, to attach a container to the conveyor, the container platform can lift a container to the correct height for the hook to intersect the opening, the conveyor can advance so that the hook does intersect the opening, and the conveyor can then advance to transport the container off of the container platform. Similarly, to detach a container from a conveyor, a container platform can be positioned beneath the container, the container platform can lift the container, and the conveyor can back up the chain to withdraw the hook from the opening.

Containers may be stored suspended from the conveyor or resting on a floor. If stored detached from the conveyor, then containers can be stored on container platforms or the conveyor and containers can have some other means of re-attaching containers. For example, a container may have a means of elongating and shortening the attachment to its ring 201. If a container is suspended, then elongating the connection to the ring lowers the container. If it is lowered sufficiently far then it will become supported by the floor and not by the conveyor hook. Then the conveyor can be reversed to remove the conveyor hook from the ring, and the connection from the container to its ring can be shortened so that the hook passes over the ring if the conveyor is advanced. That detaches a container from the conveyor. To re-attach to the conveyor, do the opposite of these steps, in reverse order. Alternatively, the conveyor may have a means of raising and lowering a conveyor hook.

Containers may have hard or soft sides. Containers may have padded surfaces inside, outside, or both, to protect containers and bicycles in case of collisions and to protect bicycles from harm when shifting inside containers or bumping into container surfaces.

Locks on containers may be used to guard against bicycle theft. When someone leaves a bicycle for storage, they may use their own lock to lock the container. Optionally, the facility may supply a lock. If it is a keyed lock, then the person leaving the bicycle may take the key while the bicycle is in storage. If it is a combination lock, then the person leaving the bicycle may reset the combination. A lock or locks used with a container may be separable from the container or an integrated part of the container. To enhance security, facility operations may forbid unauthorized people from removing containers from the site and from breaking locks at the site.

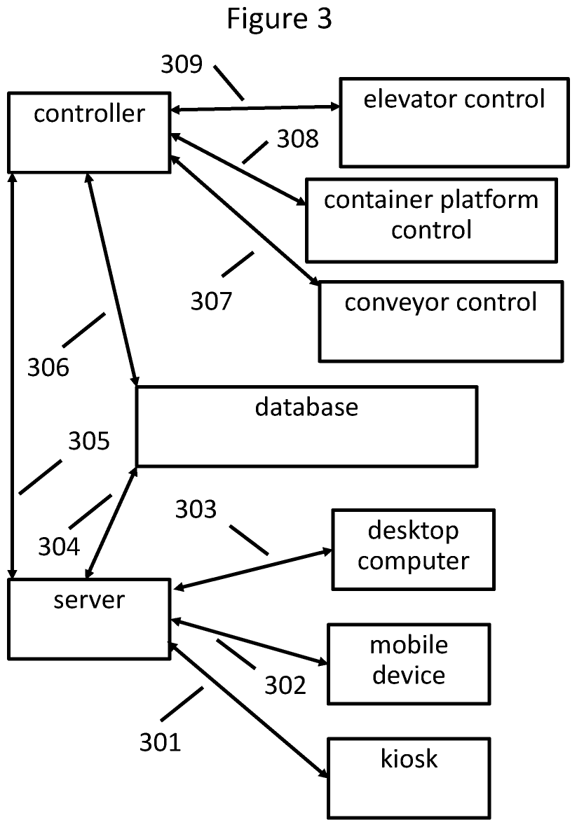

FIG. 3 shows a diagram of an information-processing system to operate the facility for storing bicycles. Each data channel (numbered in the figure) physically consists of wire, optical fiber, electromagnetic waves, or a combination of those, with protocol stacks that may include the internet or its components. Each subsystem, shown as a labeled rectangle in the FIG. 3, comprises one or more computers, each with a hardware processor and memory comprising instructions executable by the processor. Different subsystems may share one or some computers.

A person intending to leave a bicycle for storage registers the bicycle with a code, using a kiosk 301, a mobile device 302, or a desktop computer 303 to communicate with the server subsystem. The person, their device, or the server may generate the code. The code may comprise numbers, letters, symbols, or other information. The code may be communicated by printing on a physical substance such as a paper ticket or by electronic communications such as a text message to a cell phone or to a mobile phone screen via an application.

The server subsystem uses a data channel 305 to communicate with a controller subsystem to establish that a container is loaded into the elevator and has been granted a code. The controller uses a data channel 309 to signal an elevator control subsystem to lift or lower the container platform and container to a level for storage. The controller uses a data channel 308 to signal a container platform control subsystem to move the container from the elevator. The controller uses a data channel 309 to signal a conveyor control subsystem to transport the container within the level. Each control subsystem may include sensors and actuators and may use the data channel 307, 308, 309 between itself and the controller to send as well as receive data, for example signaling that a control subsystem has completed a task. The conveyor control subsystem communicates the storage location of a container to the controller using their shared data channel 307.

The control systems may communicate among one another directly. Also, if a container has an actuator, for example to lift or lower a ring on the container, that actuator may be controlled by one or more of: the controller subsystem and the control subsystems. For example, the conveyor control subsystem may signal an actuator on the container to lengthen the connection between ring and container in order to lower the container to the ground for storage.

The database subsystem stores code-location pairs. This mapping from codes to locations to aid retrieval from a conveyor is similar functionality to that found in dry-cleaning shops. The database subsystem receives a code and a corresponding container location, specifying either a position on a level if the container is stored statically or a position along a conveyor if the container is stored connected to the conveyor, from some combination of a data channel 304 shared with the server subsystem and a data channel 306 shared with the controller subsystem.

To retrieve a stored bicycle, a person communicates the code they established when storing the bicycle, using a data channel to the server subsystem from a kiosk 301, a mobile device 302, or a desktop computer 303, to identify the bicycle for retrieval. The server subsystem communicates with the database via data channel 304 to confirm that the code has a corresponding location.

If not, then the server subsystem may allow the person another attempt. After some number of failed codes, the server subsystem may do some combination of: issue an alert, block further codes from the user's device or from the user, record information about the person, and alert facility operators or law enforcement that the person may be attempting theft.

If the code corresponds to a location, then the server subsystem signals the controller, using their shared data channel 305, to retrieve the container at the specified location. The controller then uses data channels 307, 308, 309 to coordinate the retrieval of the bicycle by the conveyor control subsystem, the container platform control subsystem, and the elevator control subsystem.

The use of a code may be augmented or replaced by alternate means of identifying a person with a container. A person may swipe a credit card or identification card when leaving a bicycle for storage, the card information may be stored in the information-processing system, and a swipe of the same card may be required to retrieve the bicycle. A person may submit, or the facility information-processing system may collect, biometric data such as a fingerprint, iris scan, voice sample, or image, to be used as identifying data.

A person may use a cellular phone or other portable computing device to call, text, or use an application running on the device to send identifying data to the information-processing system when leaving a bicycle, the identifying information may be stored in the information-processing system, and the same identifying information may be required to retrieve the bicycle. The data from the device may also comprise identifying information for another person or device, to grant permission for a different person to claim the bicycle than the person who is leaving it for storage and/or a different device to be used to claim the bicycle than the device used when leaving it. The identifying information may also be transmitted before leaving the bicycle, which may be as part of an information-technology and/or financial transaction to reserve space in the facility before it is used.

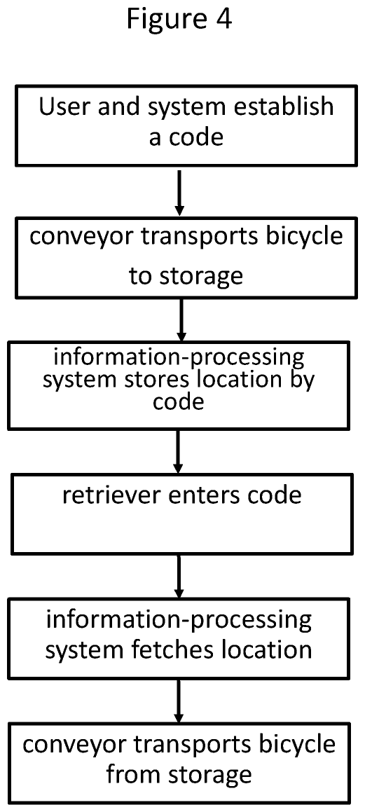

FIG. 4 shows steps in storing and retrieving a bicycle. A code is established to identify the bicycle while in storage. The bicycle is stored, using a tracked, chain-driven conveyor. The bicycle may be stored connected to the conveyor, or in a fixed location. An information-processing system stores the bicycle's location, which may be either a fixed location or a location along the chain of the conveyor, by the code. To retrieve the bicycle, the code is submitted to the information-processing system, which uses the code to find the location. Then the bicycle is retrieved from the location, using the tracked, chain-driven conveyor.

I claim:

1. A system to store a bicycle, comprising a tracked, chain-driven conveyor that suspends the bicycle while transporting it.

2. The system of claim 1, with a container to hold the bicycle and the container transported by the tracked, chain driven conveyor.

3. The system of claim 2, with the conveyor having a protrusion, such as a hook, that fits in an opening in or through the container.

4. The system of claim 3, with the container having a means of lifting and lowering the opening.

5. The system of claim 3, with the conveyor having a means to lift and lower the protrusion.

6. The system of claim 2, with the container having a means of being secured by a lock.

7. The system of claim 6, with the container having a locking mechanism.

8. The system of claim 2, with an elevator to lift and lower containers.

9. The system of claim 8, with a container platform to transfer a container between the elevator and the tracked, chain-driven conveyor.

10. The system of claim 1, with a covered structure having a ceiling over at least part of the conveyor track.

11. The system of claim 1, with an information-processing system comprising a hardware processor and memory comprising instructions executable by the processor that when executed perform functions comprising:
(a) create and store a map from codes to locations,
(b) retrieve a location from the map based on a code, and
(c) control the conveyor to transport a bicycle from the location.

12. The information-processing system of claim 11, with functionality to communicate with mobile devices to send and receive codes.

13. A method to store bicycles, comprising transporting a bicycle by a conveyor that is tracked and chain-driven.

14. The method of claim 13, with the container being locked.

15. The method of claim 14, with a lock supplied by the bicycle's owner.

16. The method of claim 13, with a code being issued to the bicycle's owner by an information-processing system before the bicycle is stored and the code communicated by the bicycle's owner to the information-processing system to identify the container to retrieve in order to retrieve the bicycle.

17. The method of claim 16, with the information-processing system storing information that links where the bicycle is stored to the code.

18. The method of claim 13, wherein the conveyor hooks the container and suspends it while transporting it to a storage location.

19. The method of claim 13, with a container platform transferring containers between the elevator and a conveyor.

20. A non-transitory medium comprising instructions that can be read and executed by computer, that when executed perform a method for storing a bicycle, the method comprising:
(a) communicating a code that corresponds to the bicycle,
(b) controlling a tracked, chain-driven conveyor to transport the bicycle to a storage location,
(c) storing a correspondence between the code and the storage location,
(d) receiving a code,
(e) retrieving the storage location that corresponds to the code, and
(f) controlling a tracked, chain-driven conveyor to transport the bicycle from a storage location.
